(19) United States
(12) Patent Application Publication
(10) Pub. No.: US 2014/0337009 A1
(43) Pub. Date: Nov. 13, 2014

(54) ENHANCING TEXT-BASED ELECTRONIC COMMUNICATIONS USING PSYCHO-LINGUISTICS

(71) Applicant: International Business Machines Corporation, (US)

(72) Inventors: Christian B. Kau, Los Altos, CA (US); Jalal U. Mahmud, San Jose, CA (US)

(21) Appl. No.: 13/888,720

(22) Filed: May 7, 2013

(51) Int. Cl. G06F 17/21

(52) U.S. Cl. CPC G06F 17/21
USPC 704/9

(57) ABSTRACT

Embodiments of the present invention relate to enhancing text-based electronic communications using psycho-linguistics. In one embodiment, a first repository that includes a predetermined general personality profile and/or a dictionary that includes words, phrases, and/or sentences that are correlated with the personality profile is generated. A second repository that includes a predetermined participant personality profile for a participant and/or a dictionary of words, phrases, and/or sentences that are correlated with the predetermined participant personality profile is generated. An analysis on the electronic communication using the first repository and/or the second repository is performed. An alternative suggestion for a word, phrase, and/or sentence included in the electronic communication that is correlated with a predetermined participant personality profile and/or a predetermined general personality profile is generated. Words included in the electronic communication that have a correlation with the predetermined participant personality profile of the participant are determined.

### BACKGROUND

The present invention relates generally to the field of psycho-linguistics, and more particularly to enhancing text-based electronic communications using psycho-linguistics. Text-based electronic communications (hereinafter “communication”) are a popular form of communication both in an enterprise (i.e. electronic mail) and in social settings (i.e. social media). Such communications involve participants, such as a sender and recipient, that have unique personalities. These unique personalities influence the outcome of the communication. For example, the outcome of an email between a developer and a project manager debating about project progress can differ depending on the personality of each participant.

A personality can be defined using personality characteristics, which provide a broad overview of a personality. Psycho-linguistic analysis is the study of the emotional, cognitive, structural, and process components present in verbal and written speech samples. It has been demonstrated that a person's personality influences their social engagement behavior, wherein people with differing personalities will exhibit differing engagement behavior.

### SUMMARY

Embodiments of the present invention relate to enhancing text-based electronic communications using psycho-linguistics. In one embodiment, a first repository that includes a predetermined general personality profile and/or a dictionary that includes words, phrases, and/or sentences that are correlated with the personality profile in generated. A second repository that includes a predetermined participant personality profile for a participant and/or a dictionary of words, phrases, and/or sentences that are correlated with the predetermined participant personality profile, wherein the participant is associated with an electronic communication is also generated.

An analysis on the electronic communication using the first repository and/or the second repository is performed. An alternative suggestion for a word, phrase, and/or sentence included in the electronic communication that is correlated with a predetermined participant personality profile and/or a predetermined general personality profile is generated. Words included in the electronic communication that have a correlation with the predetermined participant personality profile of the participant are determined.

### BRIEF DESCRIPTION OF THE SEVERAL VIEWS OF THE DRAWINGS

FIG. 1 is a block diagram illustrating an environment, in accordance with an embodiment of the present invention.

FIG. 2 is an illustration of an exemplary LIWC-based word category listing used by a program function for performing a psycho-linguistic test, in accordance with an embodiment of the present invention.

FIG. 3 illustrates a transmission and a request/response cycle that occurs during the execution of a program function, in accordance with an embodiment of the present invention.

FIG. 4 illustrates the structure of an annotated email, in accordance with an embodiment of the present invention.

FIG. 5 depicts an exemplary illustration of a personality profile generated by a program function, in accordance with an embodiment of the present invention.

FIG. 6 is a flowchart depicting operational steps of a program function, on an application server within the environment of FIG. 1, for enhancing a text-based electronic communication, in accordance with an embodiment of the present invention.

FIG. 7 depicts a block diagram of components of an application server, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

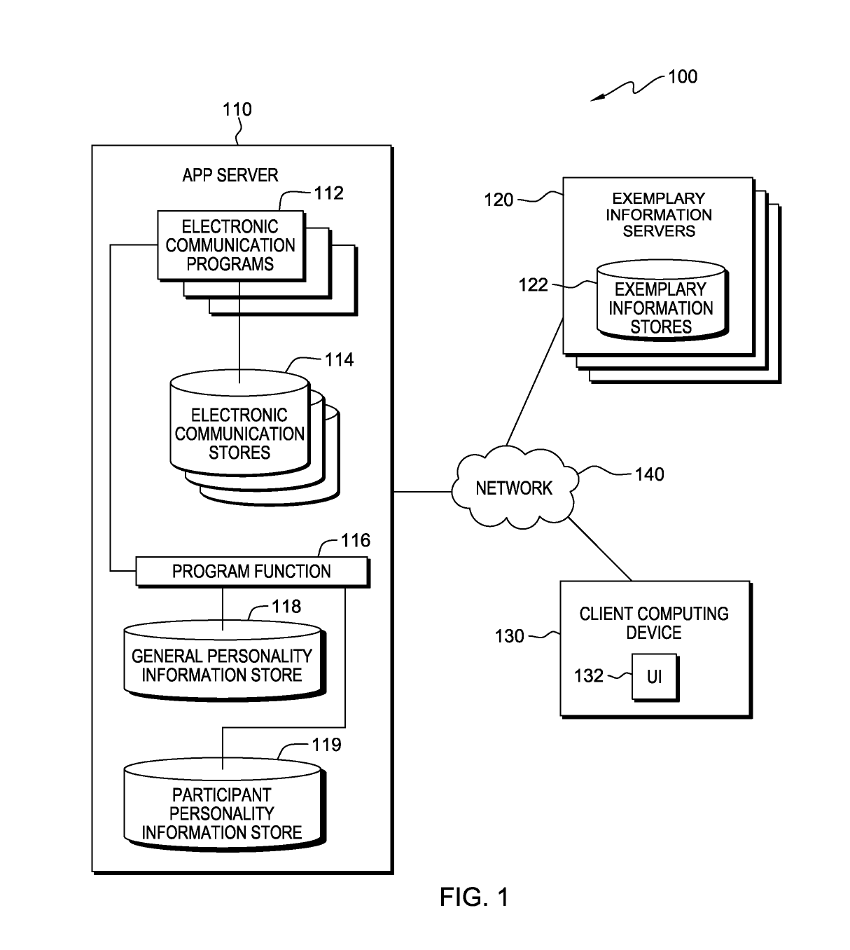

Embodiments of the present invention will now be described in detail with reference to the Figures. FIG. 1 is a block diagram illustrating an environment, generally designated 100, in accordance with an embodiment of the present invention. Environment 100 includes exemplary information servers 120, client computing device 130, and application server 110 all interconnected over network 140. Network 140 can be, for example, a local area network (LAN), a wide area network (WAN) such as the Internet, or a combination of the two, and can include wired, wireless, or fiber optic connections. In general, network 140 can be any combination of connections and protocols that will support communications between exemplary information servers 120, client computing device 130, and application server 110.

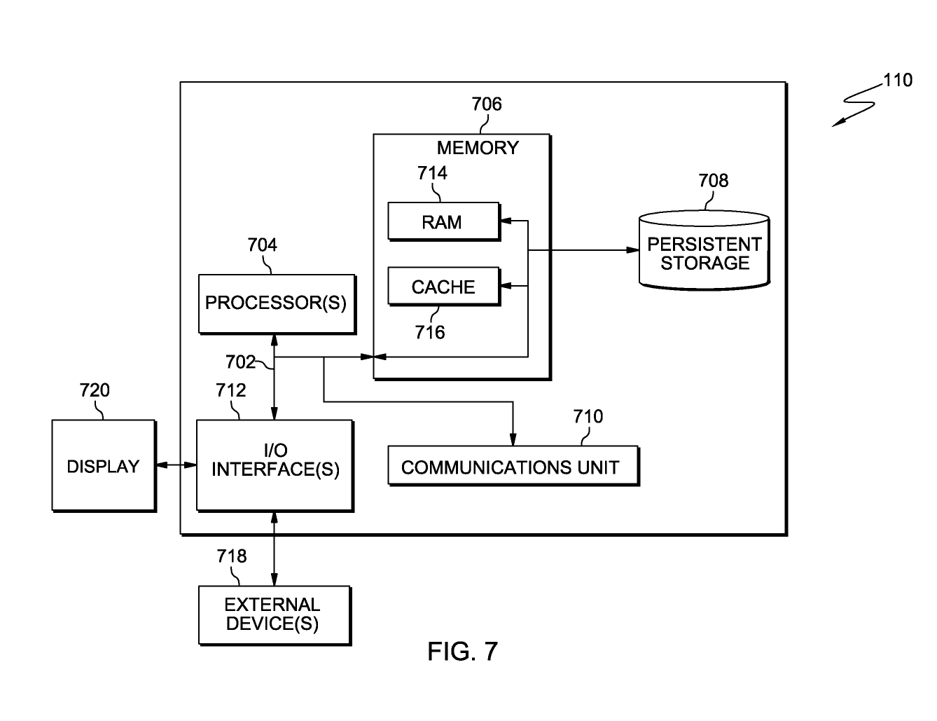

Exemplary information servers 120, client computing device 130, and application server 110 can each be, for example, a mainframe or mini computer, a laptop, tablet, or netbook personal computer (PC), or a desktop computer. In general, exemplary information servers 120, client computing device 130, and application server 110 can be any programmable electronic device capable of supporting the required functionality of an embodiment of the present invention, and as described in further detail with respect to FIG. 7.

Exemplary information servers 120 represent computing devices that provide, via network 140, exemplary information that is associated with a user of client computing device 130, to a computing device within environment 100, in accordance with an embodiment of the present invention. Exemplary information servers 120 include exemplary information stores 122, which are information repositories. Exemplary information servers 120 can transmit, via network 140, exemplary information to a computing device included within environment 100, for example, application server 110. Exemplary information servers 120 can respond to a request generated by application server 110. In general, exemplary information servers 120 can be any computing devices capable of transmitting exemplary information to application server 110, in accordance with an embodiment of the present invention.

In an embodiment, exemplary information includes a text-based electronic communication (hereinafter “communication”) associated with a social media application or an electronic mail application. In another embodiment, exemplary information includes text-based messages transmitted electronically using a messaging service, such as the Short Message Service or Multimedia Messaging Service. In yet another embodiment, exemplary information includes a text-based electronic communication associated with a calendar, event planner, and/or meeting planner. In yet still another embodiment, exemplary information includes information related to a user of client computing device 130 and/or a participant of a text-based electronic communication included in electronic communication stores 114.

Client computing device 130 is a computing device utilized to generate a communication within environment 100 of FIG. 1, in accordance with an embodiment of the present invention. Client computing device 130 includes user interface 132, which allows a user of client computing device 130 to access, via network 140, electronic communication programs 112 included in application server 110 to generate a communication. In general client computing device 130 can be any computing device capable of generating a communication, in accordance with an embodiment of the present invention.

In an embodiment of the present invention, application server 110 represents a computing device which executes a text-based electronic communication program. Application server 110 includes electronic communication programs 112 and program function 116. Application server 110 is in communication with exemplary information servers 120 and client computing device 130. Electronic communication programs 112 are programs which execute on application server 110 and assist a user utilizing client computing device 130 to generate a communication. Electronic communication programs 112 are in communication with program function 116. In an embodiment, electronic communication programs 112 include one or more of an electronic mail program, calendar program, web log posting program, meeting managing program, and/or social media application. In an embodiment, electronic communication programs 112 include any electronic communication program capable of being used by client computing device 130 to generate a communication.

Electronic communication stores 114 are information repositories, in accordance with an embodiment of the present invention. Electronic communication stores 114 are in communication with electronic communication programs 112. Electronic communication stores 114 include communications generated by electronic communications programs 112 that are associated with client computing device 130.

Program function 116 is software capable of generating a personality profile, in accordance with an embodiment of the present invention. Program function 116 is in communication with electronic communication programs 112. Program function 116 is in communication with general personality information store 118, which is an information repository that includes general personality information. In an embodiment, general personality information includes a psycho-linguistic dictionary, such as a dictionary based on the Linguistic Inquiry and Word Count (hereinafter “LIWC”). In another embodiment, the psycho-linguistic dictionary includes general personality information that further includes a crowd-sourced word association list derived from participants with predetermined personality profiles that categorized words included therein as positive or negative. Such a word association list reflects the words, phrases, and/or sentences that are positively and/or negatively correlated with a particular personality profile, in accordance with an embodiment of the present invention. In yet another embodiment, general personality information includes personality information derived from a person with a predefined personality profile, for example, defined using a personality test, such as one based on Big Five personality dimensions and/or the LIWC.

The Big Five personality dimensions are five broad dimensions that characterize a personality score and include openness, extraversion, agreeableness, conscientiousness, and neuroticism. Together the Big Five personality dimensions are used to identify the traits and structure of a personality. Each Big Five personality dimension is associated with lower level facets, which are specific and unique aspects of the broader personality dimension, as illustrated in Table 1.

TABLE 1

| Big Five Personality | |
|---|---|
| Dimensions | Lower Level Facets |
| Neuroticism | Anxiety, Anger, Depression, Self-consciousness, |
| | Immoderation, Vulnerability |
| Extraversion | Friendliness, Gregariousness, Assertiveness, |
| | Activity level, Excitement-seeking, Cheerfulness |
| Openness | Imagination, Artistic interests, Emotionality, |
| | Adventurousness, Intellect, Liberalism |
| Agreeableness | Trust, Morality, Altruism, Cooperation, Modesty, |
| | Sympathy |
| Conscientiousness | Self-efficacy, Orderliness, Dutifulness, |
| | Achievement-striving, Self-discipline, Cautiousness |

In an embodiment, program function 116 can apply a personality test based on the LIWC to analyze text, such as text in a communication, on a word-by-word, phrase-by phrase, and/or sentence-by-sentence basis, determine the percentage of words in the text that match LIWC-based word categories, and/or generate a LIWC score. Each word category contains a plurality of associated words. In an embodiment, the personality test analyzes a communication and as each word, phrase, and/or sentence is processed, the test determines whether a word, phrase, and/or sentence included therein is also included in a LIWC-based word category.

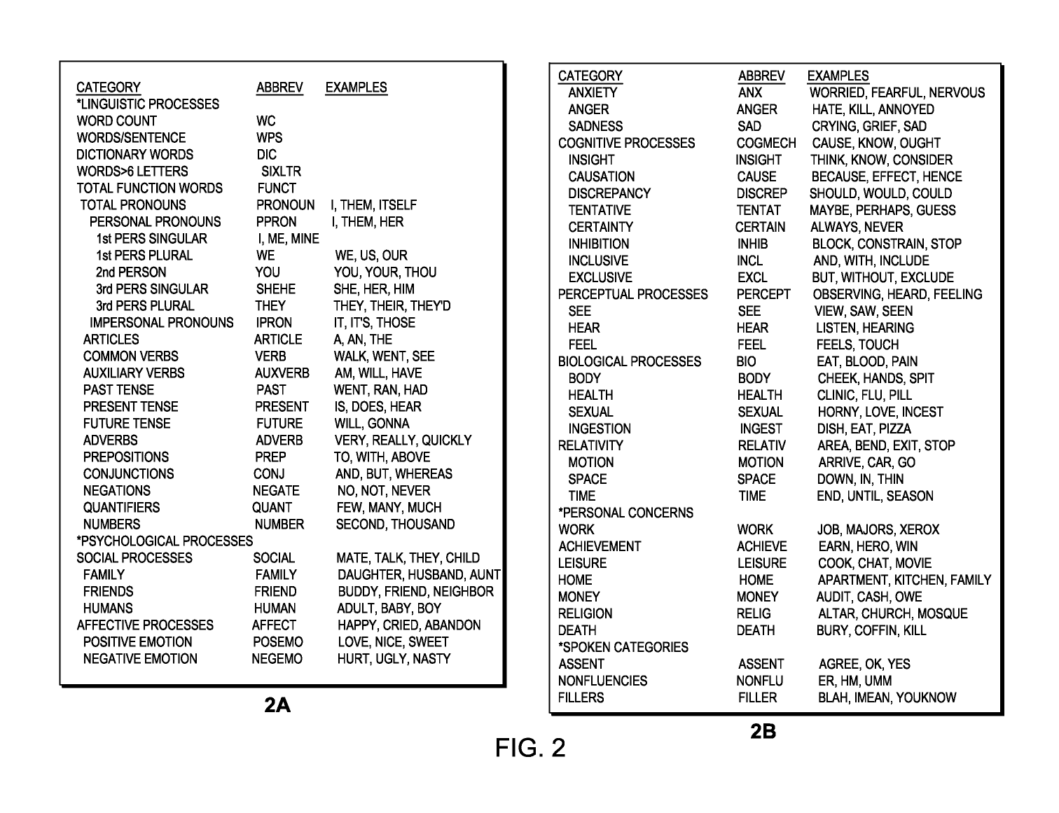

If the processed word is included in the word category, then program function 116, in applying the test, increments the appropriate word category scale. For example, the word “cried” is part of five word categories: sadness, negative emotion, overall affect, verb, and past tense verb. Hence, if found in the communication, each of these five subdictionary scale scores will be incremented. In an embodiment, the personality test also determines a Big Five personality score from a LIWC score by determining a correlation between a LIWC-based score and Big Five lower level facets using an appropriate statistical method, for example, Pearson correlation analysis. An exemplary LIWC-based word category listing is discussed in detail below in the context of FIG. 2.

Program function 116 is also in communication with participant personality information store 119, which is an information repository that includes participant personality information (hereinafter “PPI”) generated by program function 116 using a personality test. In an embodiment, PPI is personality information associated with the user of client computing device 130. In certain embodiments, PPI includes personality information associated with the recipient of a communication generated by a user of client computing device 130, via electronic communication programs 112. In another embodiment, PPI includes psycho-linguistic analysis results generated by program function 116. In yet another embodiment, PPI includes a psycho-linguistic dictionary. For example, the psycho-linguistic dictionary can be LIWC-based and/or a word association list generated by a participant that includes the words, phrases, and/or sentences that are correlated to the participant's predetermined personality profile. Program function 116 performs a psycho-linguistic analysis on a communication included in electronic communication stores 114. In another embodiment, PPI includes participant personality profiles generated by program function 116. For example, program function 116 performs a personality test on a participant generated communication included in electronic communication stores 114 and/or exemplary information stores 122 to determine the participant's personality profile.

The number of communications required to determine a personality profile varies because the amount of personality related information included in each communication is not uniform. In an embodiment, program function 116 requires a threshold level of communications authored by a participant to generate a personality profile associated with that participant. In another embodiment, a personality profile generated by program function 116 has a given level of statistically determined certainty. In yet another embodiment, a personality profile generated by program function 116 has a certain confidence level. In yet still another embodiment, a communication analyzed by program function 116 can yield additional PPI compared to another communication analyzed by the same.

In an embodiment, program function 116 performs a psycho-linguistic analysis on a communication generated by electronic communication programs 112 using a psycho-linguistic dictionary, such as a Linguistic Inquiry and Word Count based dictionary, or a Big Five personality model, on information included in general personality information store 118, information included in participant personality information store 119, and/or information included in exemplary information stores 122. In an embodiment, program function 116 generates a personality profile of a participant associated with a communication included in electronic communication stores 114 and/or exemplary information stores 122 using a personality test. In an embodiment, program function 116 can determine which words in a communication are correlated to the personality profile of a participant associated with the communication.

FIG. 2 is an illustration of an exemplary LIWC-based word category listing used by program function 116 for performing a personality test and/or psycho-linguistic test, in accordance with an embodiment of the present invention. In particular, FIG. 2 depicts a LIWC-based word category listing, as depicted in illustrations 2A and 2B. Although not shown, a category listing may also include Cronbach alphas to reflect the internal reliability of the specific words within each category and binary alphas that reflect the occurrence/non-occurrence of each dictionary word, and/or raw or uncorrected alphas that reflect the percentage of use of each of the category words within the communication.

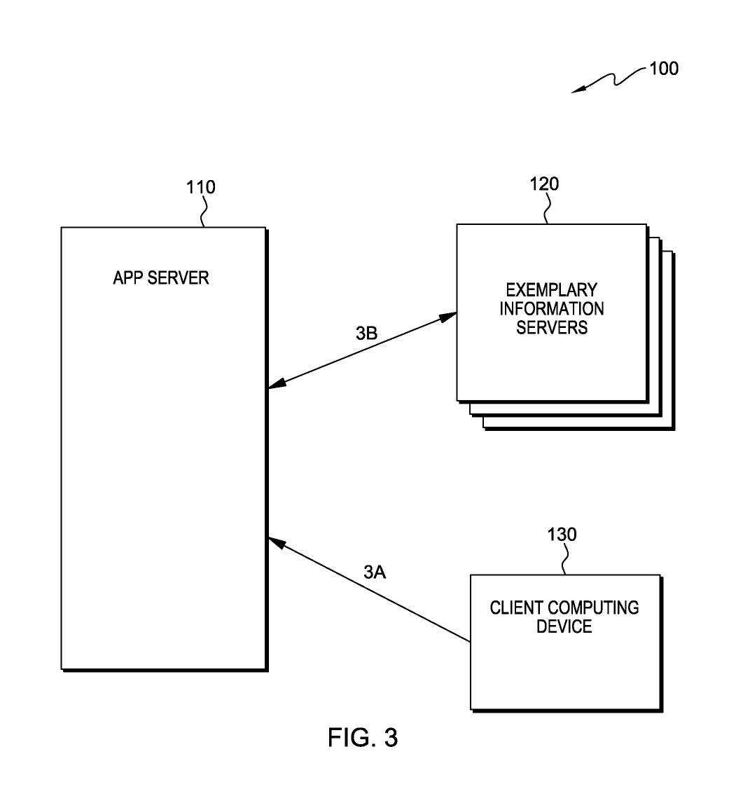

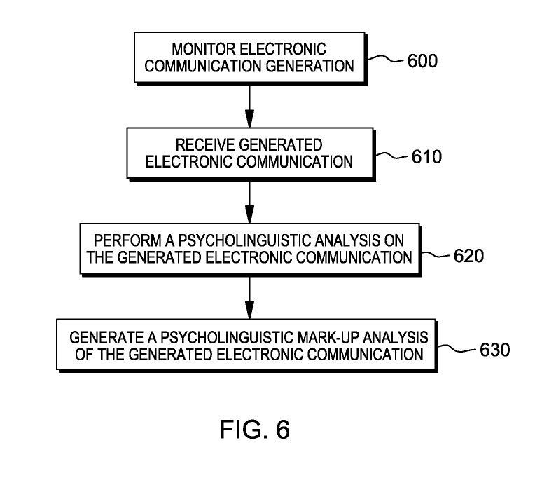

Concepts introduced in the following discussions of FIGS. 3 through 5 will be used further in the discussion of FIG. 6, in the context the environment 100 of FIG. 1. FIG. 3 illustrates a transmission and a request/response cycle (hereinafter “cycle”) that occurs during the execution of program function 116, in accordance with an embodiment of the present invention. In particular, transmission 3A initiates when a user of client computing device 130 (hereinafter “first participant”), using user interface 132, accesses, via network 140, electronic communication programs 112 and generates a communication intended for a second participant. In an embodiment, program function 116 determines whether a participant personality profile associated with the second participant is included in participant personality information store 119 is present and/or current.

In another embodiment, program function 116 determines whether electronic communication stores 114 and/or exemplary information stores 122 includes a communication generated by the second participant, if program function 116 determines that participant personality information store 119 does not include a personality profile associated with the second participant. Hence, a participant is considered new if there is no associated information included in electronic communication stores 114 (i.e. a communication generated by the participant), participant personality information store 119 (i.e. a personality profile), and exemplary information stores 122 (i.e. a communication generated by the participant).

In yet another embodiment, program function 116 updates the personality profiles included in participant personality information store 119 periodically, for example, every six to twelve months by retrieving and analyzing new participant-related communications included in electronic communication stores 114 and/or exemplary information stores 122. For example, if program function 116 determines that such a personality profile is not current, program function 116 initiates cycle 3B, requests current or recent communications generated by the second participant from exemplary information servers 120, and updates the personality profile. Cycle 3B concludes when exemplary information servers 120 retrieve the requested information from exemplary information stores 122 and transmit the requested information to program function 116 via application server 110.

In response to the conclusion of cycle 3B, program function 116 performs a psycho-linguistic analysis on the generated electronic communication. For example, program function 116, utilizing the psycholinguistic dictionary included in general personality information store 118 or in participant personality information store 119, proceeds word by word through the generated text and determines whether a word, phrase, and/or sentence included therein has a negative or positive correlation with the predetermined personality profile of the second participant. In an embodiment of the present invention, program function 116 utilizes the psycho-linguistic dictionary included in general personality information store 118 when a participant is new. In an additional embodiment, program function 116 considers a participant to be a new participant when neither electronic communications stores 114 nor exemplary information stores 122 include a communication associated with the participant and when participant personality information store 119 does not include a personality profile associated with the participant therein.

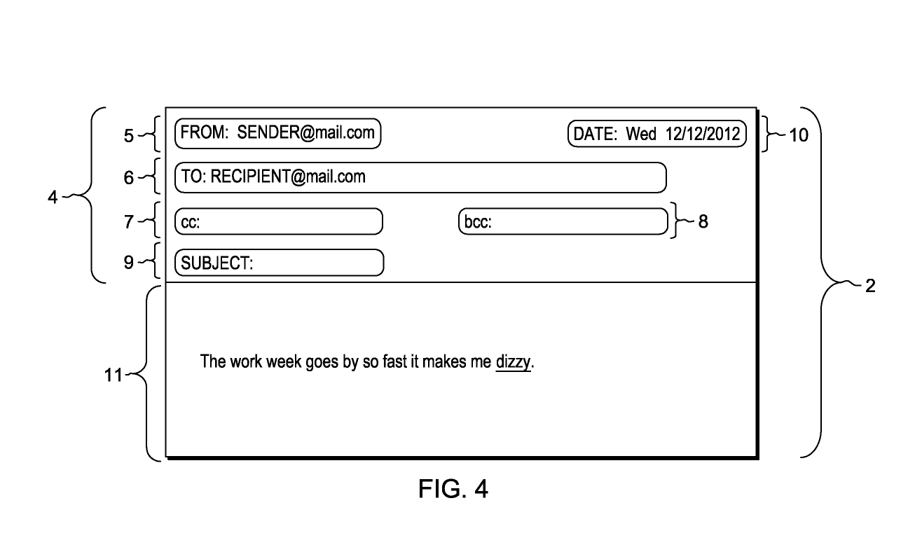

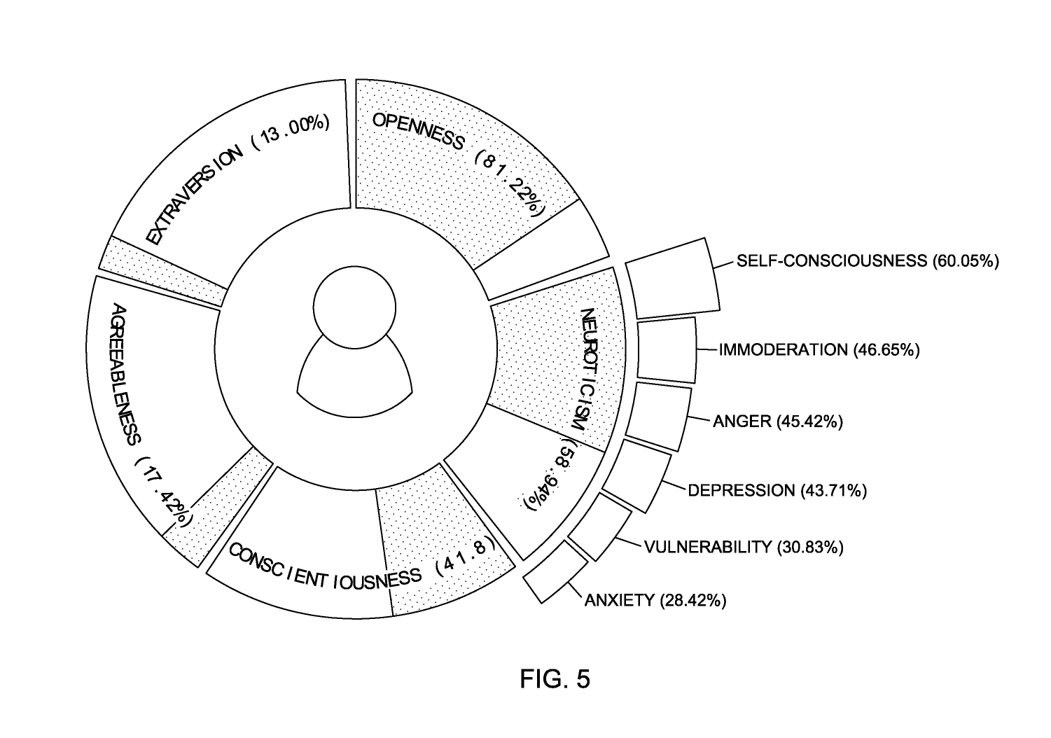

Based on said determination, program function 116 generates a psycho-linguistic markup analysis. In an embodiment, generating a psycho-linguistic markup analysis includes program function 116 providing a visual marker to denote a correlated word, phrase, and or sentence, for example, as depicted in FIG. 4 below. In another embodiment, generating a psycho-linguistic markup analysis includes program function 116 generating an alternative word, phrase, and/or sentence to replace a negatively correlated word, phrase, and/or sentence. In an embodiment, program function 116 provides visual feedback of the participant's personality profile, for example, as depicted in FIG. 5 below. In another embodiment, the visual feedback depicts a personality profile using a Big Five personality dimension, LIWC-based word category, and/or an appropriate graphical form. In yet another embodiment, program function 116 generates a visual comparison of the personality profiles of each participant of a communication generated by electronic communication programs 112.

FIG. 4 illustrates the structure of an annotated email, in accordance with an embodiment of the present invention. As illustrated in FIG. 4, the structure of annotated email 2 comprises: (a) Header field 4, which is structured into fields such as From address 5, To address 6, Carbon Copy address(es) 7, Blind Carbon Copy address(es) 8, Subject 9, Date 10; and (b) body 11, which includes a message, “The work week goes by so fast that it makes me dizzy.” The communication was generated by a first participant, SENDER@mail.com and addressed to a second participant, RECIPIENT@mail.com. According to an embodiment of the present invention, annotated email 2 also includes a word, “dizzy”, that has been determined by program function 116 to be negatively correlated with the predetermined personality profile of the second participant. In response to determining the presence of the word, program function 116 marks the word with a visual indicator, for example, an underline.

FIG. 5 depicts an exemplary illustration of a personality profile generated by program function 116, in accordance with an embodiment of the present invention. In particular, FIG. 5 illustrates a personality profile for a participant, for example, the recipient of the email of FIG. 4, wherein the personality profile reflects the following personality characteristics: 81.22% openness, 58.94% neuroticism, 41.80% conscientiousness, 17.42% agreeableness, and 13.00% extraversion. Further, variables that relate to the personality dimension neuroticism illustrate that 60.05% of the words used by the participant, as determined by program function 116, relate to self-consciousness, 46.65% relate to immoderation, 45.42% relate to anger, 43.71% relate to depression, 30.83% relate to vulnerability, and 28.42% relate to anxiety.

FIG. 6 is a flowchart depicting the operational steps of program function 116, on application server 110 within environment 100 of FIG. 1, for enhancing a text-based electronic communication, in accordance with an embodiment of the present invention. Program function 116 monitors electronic communication generation (step 600). Program function 116 receives generated electronic communications (step 610). Program function 116 performs a psycho-linguistic analysis on the generated electronic communication (step 620). Program function 116 generates a psycho-linguistic mark-up analysis of the generated electronic communication (step 630).

FIG. 7 depicts a block diagram of components of application server 110, in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

Application server 110 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 714 and cache memory 716. In general, memory 706 can include any suitable volatile or non-volatile computer-readable storage media.

Electronic communication programs 112, electronic communication stores 114, program function 116, general personality information store 118, and participant personality information store 119 are stored in persistent storage 708 for execution and/or access by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in these examples, provides for communications with other data processing systems or devices, including resources of exemplary information servers 120 and client computing device 130. In these examples, communications unit 710 includes one or more network interface cards. Communications unit 710 may provide communications through the use of either or both physical and wireless communications links. Electronic communication programs 112 and program function 116 may be downloaded to persistent storage 708 through communications unit 710.

I/O interface(s) 712 allows for input and output of data with other devices that may be connected to application server 102. For example, I/O interface 712 may provide a connection to external devices 718 such as a keyboard, keypad, a touch screen, and/or some other suitable input device. External devices 718 can also include portable computer-readable storage media such as, for example, thumb drives, portable optical or magnetic disks, and memory cards. Software and data used to practice embodiments of the present invention, e.g., electronic communication programs 112 and program function 116, can be stored on such portable computer-readable storage media and can be loaded onto persistent storage 708 via I/O interface(s) 712. I/O interface(s) 712 also connect to a display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
generating a first repository that includes a predetermined general personality profile and/or a dictionary that includes words, phrases, and/or sentences that are correlated with the personality profile;
generating a second repository that includes a predetermined participant personality profile for a participant and/or a dictionary of words, phrases, and/or sentences that are correlated with the predetermined participant personality profile, wherein the participant is associated with an electronic communication;
performing a psycho-linguistic analysis on the electronic communication using the first repository and/or the second repository, wherein performing the psycho-linguistic analysis of the electronic communication includes determining which words included in the electronic communication have a correlation with the predetermined participant personality profile of the participant; and
generating an alternative suggestion for a word, phrase, and/or sentence included in the electronic communication that is correlated with a predetermined participant personality profile and/or a predetermined general personality profile.

2. The method of claim 1, wherein the predetermined participant personality profile is determined using a psycho-linguistic dictionary and/or a personality model based analysis.

3. The method of claim 1, wherein the determining which words included in the electronic communication have a correlation with the predetermined participant personality profile of the participant includes comparing words, phrases, and/or sentences included in the electronic communication to the words, phrases, and/or sentences included in the first and/or second repository.

4. The method of claim 1, further comprising generating a visual feedback of a predetermined participant personality profile that includes a depiction of a predetermined participant personality profile that uses a personality dimension, word category, and/or an appropriate graphical form.

5. The method of claim 1, wherein a personality profile is determined by determining a correlation between a Linguistic Inquiry and Word Count based score and a Big Five lower level facet using a statistical method.

6. A computer program product, the computer program product comprising a computer readable storage medium having program code embodied therewith, the program code executable by a processor to:
generate a first repository that includes a predetermined general personality profile and/or a dictionary that includes words, phrases, and/or sentences that are correlated with the personality profile;
generate a second repository that includes a predetermined participant personality profile for a participant and/or a dictionary of words, phrases, and/or sentences that are correlated with the predetermined participant personality profile, wherein the participant is associated with an electronic communication;
perform a psycho-linguistic analysis on the electronic communication using the first repository and/or the second repository, wherein performing the psycho-linguistic analysis of the electronic communication includes program code to determine which words included in the electronic communication have a correlation with the predetermined participant personality profile of the participant; and;
generate an alternative suggestion for a word, phrase, and/or sentence included in the electronic communication that is correlated with a predetermined participant personality profile and/or a predetermined general personality profile.

7. The computer program product of claim 6, wherein the predetermined participant personality profile is determined using a psycho-linguistic dictionary and/or a personality model based analysis.

8. The computer program product of claim 6, wherein the program code to determine which words included in the electronic communication have a correlation with the predetermined participant personality profile of the participant includes program code to compare words, phrases, and/or sentences included in the electronic communication to the words, phrases, and/or sentences included in the first and/or second repository.

9. The computer program product of claim 6, further comprising program code to generate a visual feedback of a predetermined participant personality profile that includes a depiction of a predetermined participant personality profile that uses a personality dimension, word category, and/or an appropriate graphical form.

10. The computer program product of claim 6, wherein a personality profile is determined by determining a correlation between a Linguistic Inquiry and Word Count based score and a Big Five lower level facet using a statistical method.

11. A computer system, the computer system comprising:
one or more computer processors;
one or more computer-readable storage media;
program instructions stored on the computer-readable storage media for execution by at least one of the one or more processors, program instructions:
generate a first repository that includes a predetermined general personality profile and/or a dictionary that includes words, phrases, and/or sentences that are correlated with the personality profile;
generate a second repository that includes a predetermined participant personality profile for a participant and/or a dictionary of words, phrases, and/or sentences that are correlated with the predetermined participant personality profile, wherein the participant is associated with an electronic communication;
perform a psycho-linguistic analysis on the electronic; and communication using the first repository and/or the second repository, wherein program code to perform the psycho-linguistic analysis of the electronic communication includes program code to determine which words included in the electronic communication have a correlation with the predetermined participant personality profile of the participant; and
generate an alternative suggestion for a word, phrase, and/or sentence included in the electronic communication that is correlated with a predetermined participant personality profile and/or a predetermined general personality profile.

12. The computer system of claim 11, wherein the predetermined participant personality profile is determined using a psycho-linguistic dictionary and/or a personality model based analysis.

13. The computer system of claim 11, wherein the program code to determine which words included in the electronic communication have a correlation with the predetermined participant personality profile of the participant includes program code to compare words, phrases, and/or sentences included in the electronic communication to the words, phrases, and/or sentences included in the first and/or second repository.

14. The computer system of claim 11, further comprising program code to generate a visual feedback of a predetermined participant personality profile that includes a depiction of a predetermined participant personality profile that uses a personality dimension, word category, and/or an appropriate graphical form.

15. The computer system of claim 11, wherein a personality profile is determined by determining a correlation between a Linguistic Inquiry and Word Count based score and a Big Five lower level facet using a statistical method.
